(19) United States
(12) Patent Application Publication
(10) Pub. No.: US 2014/0233224 A1
(43) Pub. Date: Aug. 21, 2014

(54) LIGHT-SENSING ILLUMINATION SYSTEM

(71) Applicant: Deborah Lemon, Carrollton, TX (US)

(72) Inventor: Deborah Lemon, Carrollton, TX (US)

(21) Appl. No.: 14/180,796

(22) Filed: Feb. 14, 2014

Related U.S. Application Data
(60) Provisional application No. 61/765,974, filed on Feb. 18, 2013.

(51) Int. Cl. F21V 23/04; F21V 19/00

(52) U.S. Cl. CPC F21V 23/0464; F21V 19/001
USPC 362/191; 362/157

(57) ABSTRACT

In one aspect, the present invention relates to an illumination system including a power source, a light source electrically coupled to the power source, and a light sensor electrically coupled to the power source and the light source. The light sensor activates the light source responsive to a pre-determined minimum-lumen threshold being reached. The illumination system is placed inside an interior of a dark area.

### CROSS-REFERENCE TO RELATED APPLICATIONS

This application claims priority to, and incorporates by reference for any purpose the entire disclosure of, U.S. Provisional Patent Application No. 61/765,974, filed Feb. 18, 2013.

### BACKGROUND

1. Field of the Invention

The present application relates generally to illumination systems and more particularly, but not by way of limitation, to dark-area-illumination systems (“DAIS”) utilizing both a light source and a light sensor coupled thereto. The DAIS may, in one embodiment, be connected to an object, such as keys, which are often disposed inside, for example, a dark purse. In another embodiment, the DAIS may be connected to a lighting system for the dark area, such as, for example, a closet.

2. History of the Related Art

Dark areas requiring illumination are found frequently in the home and in the workplace. Dark areas include closets, attic spaces, basements, crawl spaces, and the like. Other examples of dark areas include containers such as purses, handbags, briefcases, and backpacks, which are very prevalent and useful to both children and adults alike. Frequently, dark areas do not permit infiltration of ambient light thereby reducing ambient illumination of the dark areas, particularly in low-ambient-light conditions. This can present problems when trying to locate objects such as, for example, a set of keys disposed within, for example, a dark purse.

Illumination systems have been developed and integrated into various articles such as purses, handbags, briefcases, backpacks, and the like to provide illumination when the article is opened. Such illumination systems frequently utilize various types of user-actuated switches to activate a lamp. For example, U.S. Pat. No. 8,147,086 discloses a purse light with a touch-sensitive switch. The purse light includes a light-emitting portion, a power source, and a touch-sensitive switch. U.S. Pat. No. 7,246,915 discloses a receptacle illumination device. The device includes a light-emitting membrane electrically connected to a power supply and a switch. U.S. Pat. No. 6,508,568 discloses a light assembly for an interior of a purse. The light assembly includes an illumination source, a power source, and a switch assembly. U.S. Pat. No. 4,954,934 discloses a purse light having a switch that actuates a battery-powered light when the switch is in an “on” position. Finally, U.S. Pat. No. 4,934,790 discloses a purse-light system having an illumination lamp that is activated for a pre-determined period of time by closing a momentary-contact switch.

Switch-actuated illumination systems rely on a user's ability to find and actuate a switch. Such a task may be made considerably more difficult in low-ambient-light environments such as a darkened closet or a darkened movie theater.

### SUMMARY

The present application relates generally to illumination systems and more particularly, but not by way of limitation to a DAIS utilizing a light sensor. In one aspect, the DAIS is adapted for coupling to keys or the like to facilitate the location thereof. The DAIS includes a power source, a light source electrically coupled to the power source, and a light sensor electrically coupled to the power source and the light source. The light sensor activates the light source responsive to a pre-determined minimum-lumen threshold being reached. The DAIS is coupled to an object, such as keys and placed inside an interior of a dark area to facilitate finding said keys.

In another aspect, the present invention relates to a method for providing illumination to an interior of a dark area, such as a closet. The method includes placing a DAIS into an interior of a dark area and connecting the DAIS to either an independent light source and/or an electrical system servicing the dark area. The method further includes determining if a pre-determined minimum-lumen threshold has been reached. Responsive to the pre-determined minimum-lumen threshold being reached, a light source is activated. Light is emitted from the light source in an amount greater that the pre-determined minimum-lumen threshold. The light source is then deactivated after a period of time, which may be variable and used in combination with other light-activation and de-activation systems.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is a schematic diagram of a DAIS according to an exemplary embodiment;

FIG. 2 is a perspective view of the DAIS of FIG. 1 according to an exemplary embodiment;

FIG. 3 is a front view of the DAIS of FIG. 1 according to an exemplary embodiment;

FIGS. 4A-4D are rear views of the DAIS of FIG. 1 according to various exemplary embodiments;

FIG. 5A is a flow diagram of a process for providing illumination to an interior of a dark area according to an exemplary embodiment; and

FIG. 5B is a flow diagram of a process for providing illumination to an interior of a dark area utilizing a timer according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

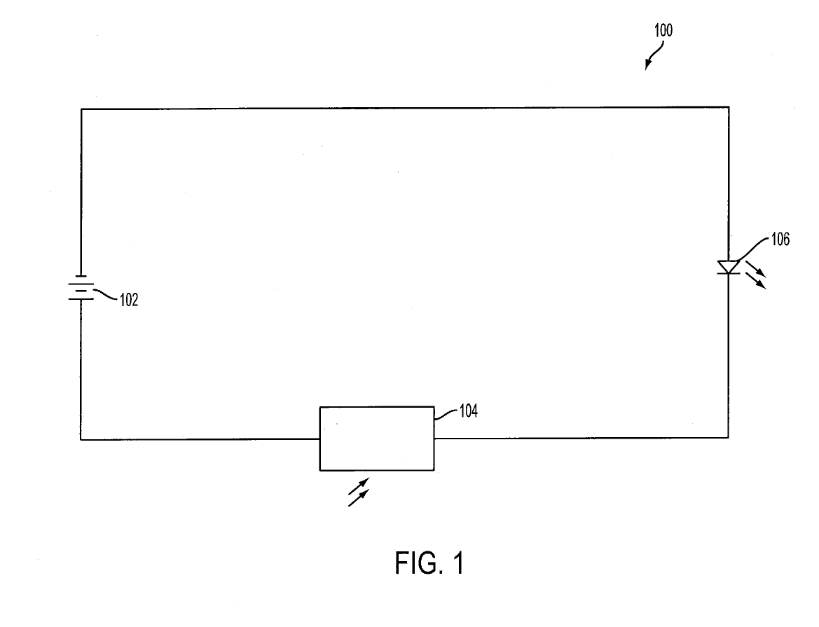

FIG. 1 is a schematic diagram of a DAIS according to an exemplary embodiment. A DAIS 100 includes a power source 102, a light sensor 104 electrically coupled to the power source 102, and a light source 106 electrically coupled to the power source 102 and the light sensor 104. The light source 106 is illustrated by way of example in FIG. 1 as a light-emitting diode (LED); however, illumination systems utilizing principles of the invention may include, for example, an incandescent lamp, a halogen lamp, a fluorescent lamp, a cold-cathode gas-discharge lamp, or any other appropriate light source. In a typical embodiment, the light source 106 emits soft white visible light; however, in other embodiments, the light source 106 may emit visible light of any color. For example in light-sensitive conditions such as, for example, a photographic dark room, other colors of visible light such as, for example, red, may be utilized. In a typical embodiment, the light sensor 104 is a photovoltaic cell; however, illumination systems utilizing principles of the invention may include, for example, a photo-transistor, a photo-resistor, or any other appropriate device. By way of example, the power source 102, the light sensor, 104, and the light source 106 are illustrated in FIG. 1 as being connected in series; however, in other embodiments, the power source 102, the light sensor 104, and the light source 106 may be connected in any appropriate arrangement.

During operation, the light sensor 104 detects a level of ambient light. When the level of ambient light rises above a pre-determined minimum-lumen threshold, the light sensor 104 activates the light source 106 and visible light is emitted from the light source 106. During periods where the level of ambient light is below the pre-determined minimum-lumen threshold, the light sensor 104 does not activate the light source 106 and no visible light is emitted from the light source 106. In a typical embodiment, the power source 102 is an electro-chemical cell such as, for example, a nickel-cadmium battery, a lithium-ion battery, or the like. In other embodiments, the power source 102 may be, for example, a photo-voltaic cell or other appropriate power source. In a typical embodiment, the power source 102 is rechargeable. In an exemplary embodiment, the power source 102 includes a universal serial bus (“USB”) connection (not shown). The USB connection allows the power source 102 to be recharged via, for example, a car, a computer, or an electrical outlet. In some embodiments, the USB connections may allow a user, via, for example, a computer, to configure an illumination time of the light source 106 or a color of the light source 106. The USB connection may also allow the user to configure the light source 106 to function as a strobe light.

In another exemplary embodiment, the power source 102 is rechargeable via electromagnetic charging. A power station (not shown) is connected to an electrical outlet. The DAIS 100 is received and charged by the charging station. An electromagnetic connection holds the DAIS 100 to the charging station.

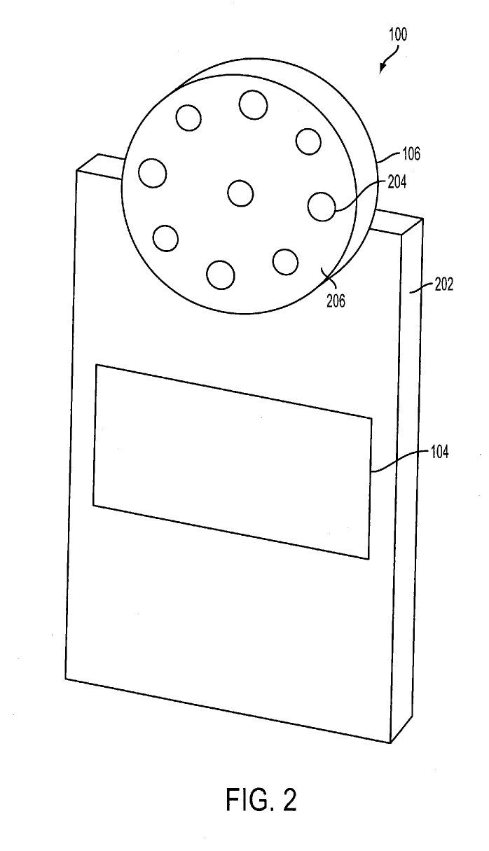

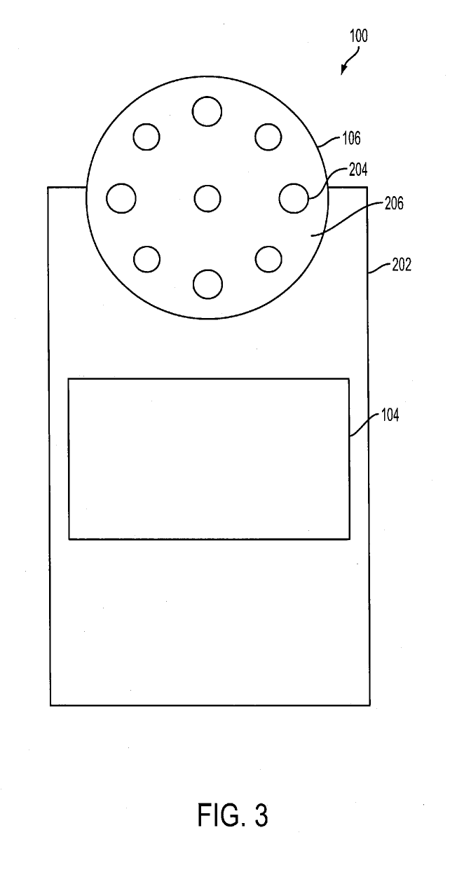

FIG. 2 is a perspective view of the DAIS of FIG. 1 according to an exemplary embodiment. FIG. 3 is a front view of the DAIS of FIG. 1 according to an exemplary embodiment. Referring to FIGS. 2-3, the DAIS 100 includes the light source 106 and a housing 202. In a typical embodiment, the housing 202 contains the power source 102 (shown in FIG. 1). The light sensor 104 is formed on a front surface of the housing 202. In a typical embodiment, the housing 202 is sized to fit inside a purse, handbag, briefcase, backpack, or other dark area. In an exemplary embodiment, the housing 202 may be sized to be approximately 2 inches tall, approximately 1 inch wide, and approximately 0.25 inches thick. However, in other embodiments, the housing 202 may be of any appropriate size or shape such as, for example, cylindrical, triangular, or other appropriate shape.

As shown in FIGS. 2-3, the light source 106 includes a light array 204. The light array 204 is shown by way of example in FIGS. 2-3 as including nine lamps arranged in a generally circular pattern. In other embodiments, illumination systems utilizing principles of the invention may include light arrays including any number of lamps. A reflective surface 206 is disposed behind the light array 204. In a typical embodiment, the reflective surface 206 directs light emitted from the light array 204 in a generally forward direction. In some embodiments, the reflective surface 206 may be omitted. In various embodiments, a filter (not shown) may be utilized to adjust the color of light emitted from the light array 204.

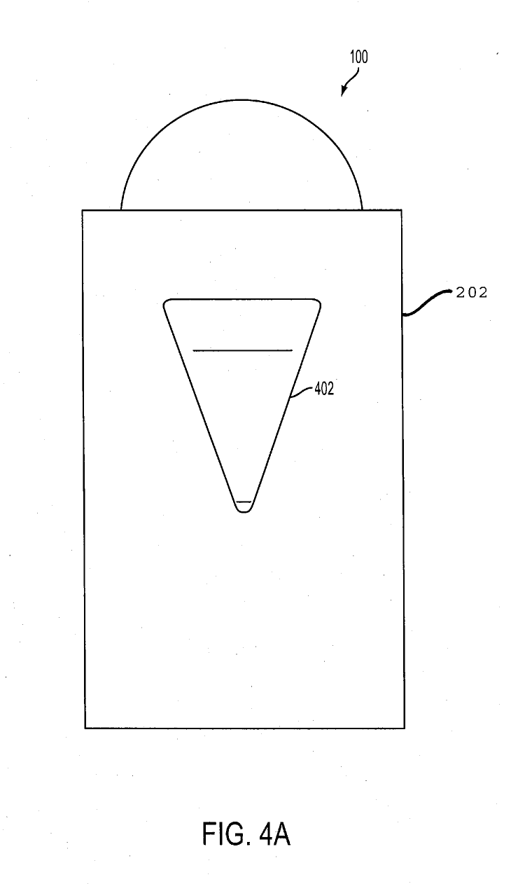

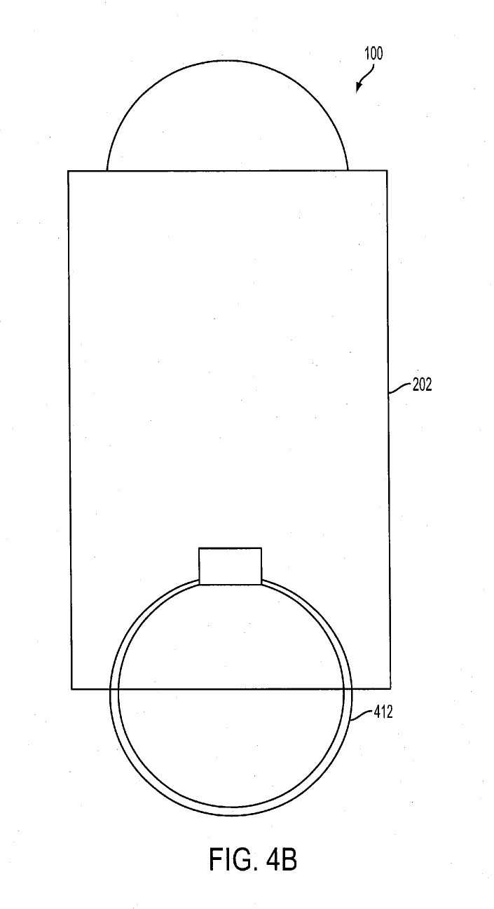

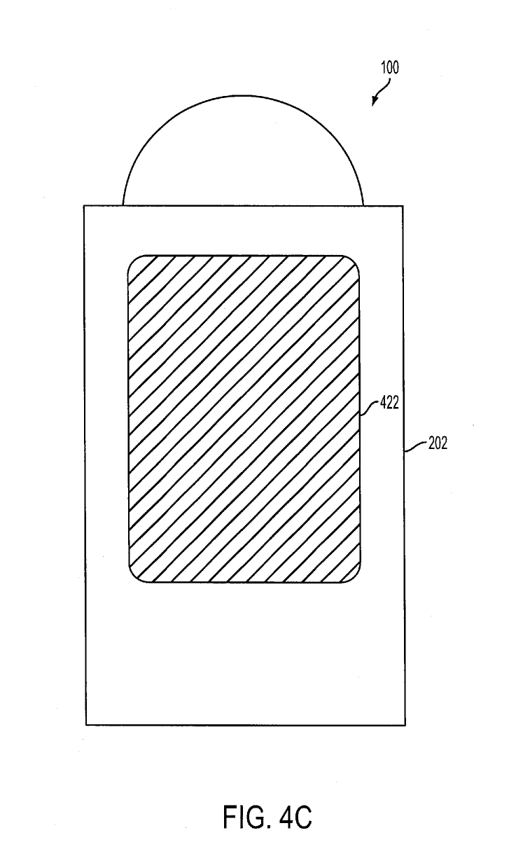

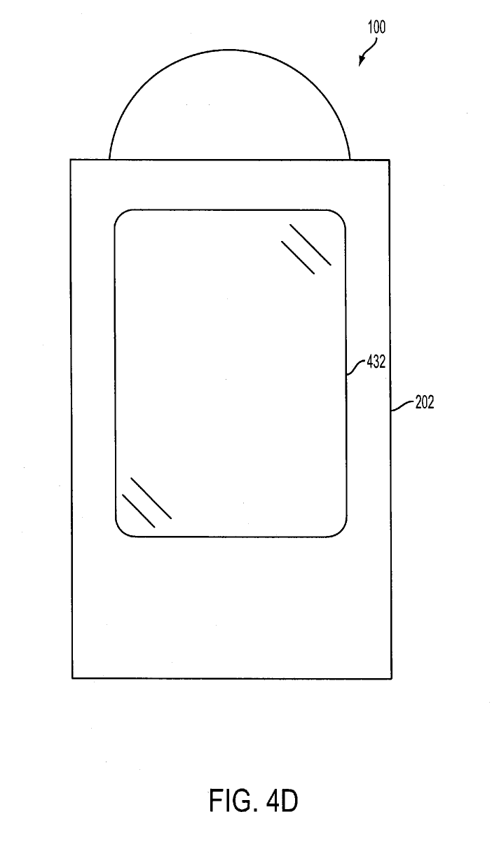

FIGS. 4A-4D are rear views of the DAIS of FIG. 1 according to various exemplary embodiments. As shown in FIG. 4A, a clip 402 is disposed on a rear surface of the housing 202. In a typical embodiment, the clip 402 may be, for example, a lobster claw jewelry clasp, a spring clip, a carabiner, or any other appropriate device. During operation, the clip 402 is utilized to secure the DAIS 100 with a dark area (not explicitly shown) such as, for example, an attic, a closet, a basement, a crawl space, a photographic dark room, a purse, a diaper bag, a briefcase, a suitcase, a gym bag, a pet accessory bag, a cloth grocery bag, a tote bag, a makeup bag, an overnight bag, a map case, a locker, a backpack, a lunch bag, a flight bag, an emergency medical kit, a laundry bin, a storage box, a camera bag, a hobby container, a picnic basket, an outdoor equipment container, a closet, a cabinet, a desk drawer, a chest, a trunk, and the like. In other embodiments, the clip 402 is utilized to secure the DAIS to an object such as, for example, a set of keys.

As shown in FIG. 4B, a ring 412 such as, for example, a key ring is coupled to the rear surface of the housing 202. The ring 412 facilitates attachment of the DAIS 100 to the interior of the dark area (not explicitly shown). Alternatively, the ring 412 facilitates attachment of the DAIS to an object such as, for example, a set of keys, which is typically placed inside a dark area. As shown in FIG. 4C, a fastener 422 is coupled to the rear face of the housing 202. In a typical embodiment, the fastener 422 may be, for example, a hook and pile fastener such as Velcro™, or an adhesive fastener such as a double-sided adhesive. As shown in FIG. 4D, a magnet 432 is coupled to the rear face of the housing 202. The magnet 432 facilitates attachment of the DAIS 100 to the interior of the dark area.

Referring to FIGS. 1-4D, during operation, the DAIS 100 is placed within an interior of a dark area (not shown). If the level of ambient light is below the pre-determined minimum-lumen threshold, such as, for example, during periods when the dark area is closed, the light sensor 104 does not activate the light source 106 and no visible light is emitted from the light source 106. When the level of ambient light produced outside the dark area rises above the pre-determined minimum-lumen threshold, such as when the dark area is opened, the light sensor 104 activates the light source 106.

In various embodiments, an amount of illumination provided by the light source 106 may be varied according the level of ambient light. For example, if the user is in low light conditions, such as a darkened movie theater, the light source 106 may emit less light than if the user were in well-lit conditions.

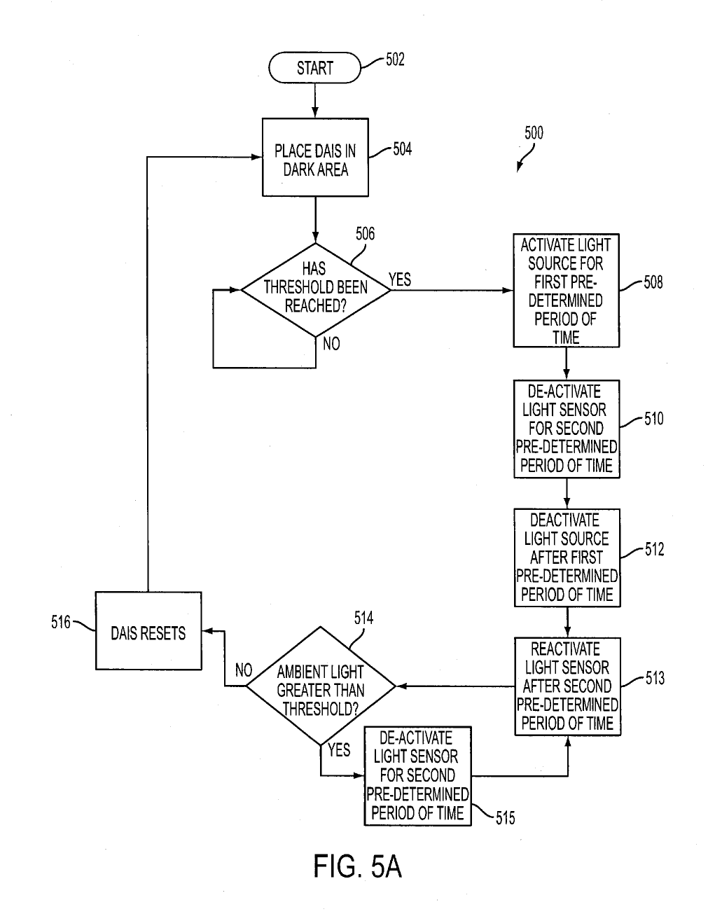

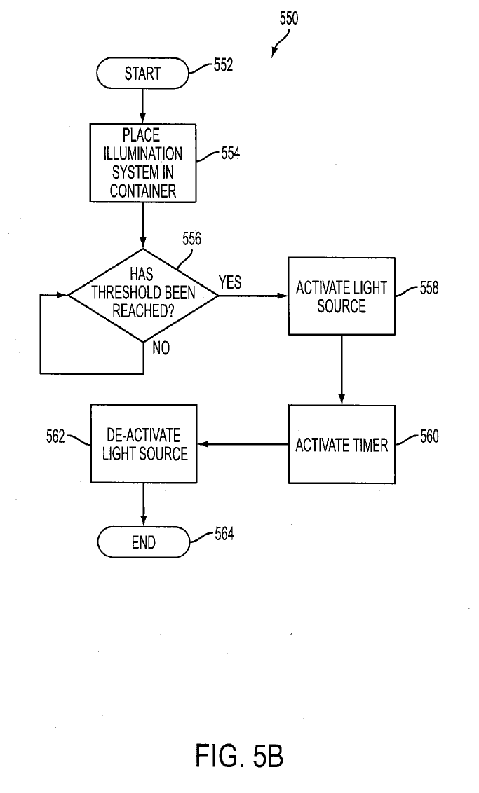

FIG. 5A is a flow diagram of a process for providing illumination to an interior of a dark area according to an exemplary embodiment. A process 500 begins at step 502. At step 504 the DAIS 100 is placed inside a dark area. In an exemplary embodiment, the DAIS 100 is attached to an object such as, for example, a set of keys, which is disposed within the dark area. At step 506, the light sensor 104 determines if a level of ambient light produced outside the dark area has reached the pre-determined minimum-lumen threshold. At step 508, if the pre-determined minimum-lumen threshold has been reached, the light sensor 104 activates the light source 106 for a first pre-determined period of time such as, for example, 20 seconds.

At step 510, upon activation of the light source 106, the light sensor 104 is deactivated for a second pre-determined period of time such as, for example 1 second. At step 512, the light source 106 is de-activated after the first pre-determined period of time. At step 513, the light sensor 104 is re-activated after the second pre-determined period of time. At step 514, the light sensor 104 determines if light is present in an amount greater than the pre-determined minimum-lumen threshold. At step 515, if the light sensor 104, after re-activation, continues to detect ambient light in an amount greater than the pre-determined minimum-lumen threshold, as would be the case if the DAIS 100 is removed from the dark area, the light sensor 104 again deactivates and the light source 106 remains deactivated. The light sensor 104 remains deactivated for the second pre-determined period of time. Steps 513 through 514 are repeated until the light sensor 104 detects ambient light below the pre-determined minimum lumen threshold. Such an arrangement allows the DAIS 100 to enter a “hibernation” period during times when the DAIS 100 is in areas of adequate illumination. At step 516, when the light sensor 104 detects ambient light below the pre-determined minimum-lumen threshold, as would be the case when the DAIS 100 is again placed into the dark area, the DAIS 100 resets and the process 500 returns to step 504.

FIG. 5B is a flow diagram of a process for providing illumination to an interior of a dark area utilizing a timer according to an exemplary embodiment. A process 550 begins at step 552. At step 554 the DAIS 100 is placed inside a dark area. In an exemplary embodiment, the DAIS 100 is attached to an object such as, for example, a set of keys, which is disposed within the dark area. In other embodiments, the DAIS 100 is placed inside a dark area such as, for example, a closet. In such embodiments, the DAIS may be electrically coupled to an electrical system servicing the dark area. At step 556, the light sensor 104 determines if the pre-determined minimum-lumen threshold has been reached. At step 558, if the pre-determined minimum-lumen threshold has been reached, the light sensor 104 activates the light source 106. In an exemplary embodiment, the light source 106 is directed to illuminate, for example, a light switch that is electrically coupled to a primary illumination system.

Still referring to FIG. 5B, upon activation, the light source 106 emits visible light in an amount greater than the pre-determined minimum-lumen threshold. At step 560, a timer is activated to measure a pre-determined amount of time. At step 562, when the timer reaches the pre-determined amount of time, the light source 106 is de-activated. The process 550 ends at step 564. Such an arrangement allows sufficient time for the user to locate, for example, the light switch.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. An illumination system comprising:
a power source;
a light source electrically coupled to the power source;
a light sensor electrically coupled to the power source and the light source;
wherein the light sensor activates the light source responsive to a pre-determined minimum-lumen threshold being reached; and
wherein the illumination system is placed into an interior of a dark area.

2. The illumination system of claim 1, wherein the light source is a light array.

3. The illumination system of claim 1, wherein the light source is a light-emitting diode.

4. The illumination system of claim 1, comprising a universal serial bus connection.

5. The illumination system of claim 4, wherein the universal serial bus connection charges the power source.

6. The illumination system of claim 4, wherein the universal serial bus connection facilitates programming of the power source.

7. The illumination system of claim 1, comprising a clip.

8. The illumination system of claim 1, comprising a ring.

9. The illumination system of claim 1, comprising a fastener.

10. A method for providing illumination to an interior of a dark area, the method comprising:
placing an illumination system into an interior of a dark area;
determining if a pre-determined minimum-lumen threshold has been reached;
responsive to the pre-determined minimum-lumen threshold being reached, activating a light source;
emitting light from the light source in an amount greater than the pre-determined minimum-lumen threshold.

11. The method of claim 10, comprising deactivating the light source after a pre-determined time period.

12. The method of claim 10, comprising deactivating the light sensor for a pre-determined period of time.

13. The method of claim 12, comprising reactivating the light sensor after the pre-determined period of time.

14. The method of claim 13, comprising, responsive to detection by the light sensor of ambient light above the pre-determined minimum-lumen threshold, deactivating the light source.

15. The method of claim 13, comprising, responsive to detection by the light sensor of ambient light below the pre-determined minimum-lumen threshold, deactivating the light source for the pre-determined period of time.

16. The method of claim 10, wherein the light source is a light-emitting diode.

17. The method of claim 10, wherein the light source is a light array.
